(19) United States
(12) Patent Application Publication
(10) Pub. No.: US 2009/0182798 A1
(43) Pub. Date: Jul. 16, 2009

(54) METHOD AND APPARATUS TO IMPROVE THE EFFECTIVENESS OF SYSTEM LOGGING

(75) Inventors: Jia-Yang Chang, Hsinchu County (TW); Jia-Ching Lin, Taichung County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/972,783

(22) Filed: Jan. 11, 2008

(51) Int. Cl. G06F 15/16

(52) U.S. Cl. 709/201

(57) ABSTRACT

The disclosure relates to an apparatus to improve the performance of system logging. The apparatus comprises a buffer storing a log, a log register comprising a bit, and a core unit. The core unit is coupled to the buffer and the log register to acquire and transmit the log to an external computer host when detecting that the bit is asserted.

### BACKGROUND OF THE INVENTION

1. Field of the Invention

The invention relates to a system logging method, and more particularly to a method to improve the effectiveness of system logging.

2. Description of the Related Art

In computerized data logging, a computer program may automatically record events in a certain scope in order to provide an audit trail that can be used to diagnose problems. Logs are essential to understanding the activities of complex systems, and to analyze problems, particularly in the case of applications with little user interaction (such as server applications). Most operating systems and software frameworks also provide more sophisticated services for logging. In the simplest case, log messages are written to a log file by a common software module. However, the common software module may become a resource bottleneck when many hardware or software systems simultaneously requesting logging services thereto, resulting in decreased system performance.

### BRIEF SUMMARY OF THE INVENTION

The disclosure relates to an apparatus to improve the performance of system logging.

An embodiment of a system logging apparatus comprises a buffer storing a log, a log register comprising a bit, and a core unit. The core unit is coupled to the buffer and the log register to acquire and transmit the log to an external computer host when detecting that the bit has been asserted.

Another embodiment of a system logging apparatus is disclosed. The apparatus comprises a first buffer storing a first log, a second buffer storing a second log, a log register comprising a first bit and a second bit, a first core unit, a second core unit and an arbiter. The first core unit is coupled to the first buffer and the log register to acquire and transmit the first log to an external computer host when detecting that the first bit is asserted. The second core unit is coupled to the second buffer and the log register to acquire and transmit the second log to the external computer host when detecting that the second bit is asserted. The arbiter is coupled to the first and second core units and grants a bus control to the first core unit or the second core unit according to predetermined priorities of the first and the second core units.

An embodiment of a system logging method is disclosed. The method comprises writing a log to a buffer, and asserting a bit of a log register to direct a core unit of the electronic apparatus to transmit the log to an external computer host after completely writing the log.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a hardware architecture diagram of a system logging apparatus according to an embodiment of the invention.

FIG. 2 is a flowchart illustrating log generation by a software program executed by a processor according to an embodiment of the invention.

FIG. 3 is a schematic diagram of the data format of logs stored in a buffer.

FIG. 4 shows a schematic diagram of an embodiment of a log register according to the invention.

FIG. 5 is a schematic diagram of a ring buffer with two pointers according to an embodiment of the invention.

FIG. 6 is a hardware architecture diagram of a system logging apparatus according to another embodiment of the invention.

FIG. 7 is a flowchart illustrating log generation by a software program executed in a processor according to another embodiment of the invention.

FIG. 8 shows a schematic diagram of an embodiment of a log register according to the invention.

FIG. 9 is a schematic diagram showing an exemplary log transmission according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In the multi-thread or multi-tasks system, a buffer or a queue is utilized to store the logs, generated by different modules, in sequence. Then, a specific software module, accesses the buffer or queue to process the received logs. The software module may generate a checksum value corresponding to a received log and pack the received logs with the generated checksum value in a specific format. Then, the software module transmits the processed logs to an external computer host or a destination terminal via the interface, such as the Universal Asynchronous Receiver Transmitter (UART), Universal Serial Bus (USB), IEEE 1394 or similar interface. Since the software module shares the same system resources, mainly provided by the CPU, with other modules, the priority of the software module is the key point of the system performance. If the priority of the software module is too low, the logs may not be processed in time. If the priority of the software module is too high, the other modules may not operate normally. Furthermore, the size of the buffer or queue also affects the data processing amount of the software module. If the buffer or queue is full, the following logs may be discarded and the important system information may therefore disappear.

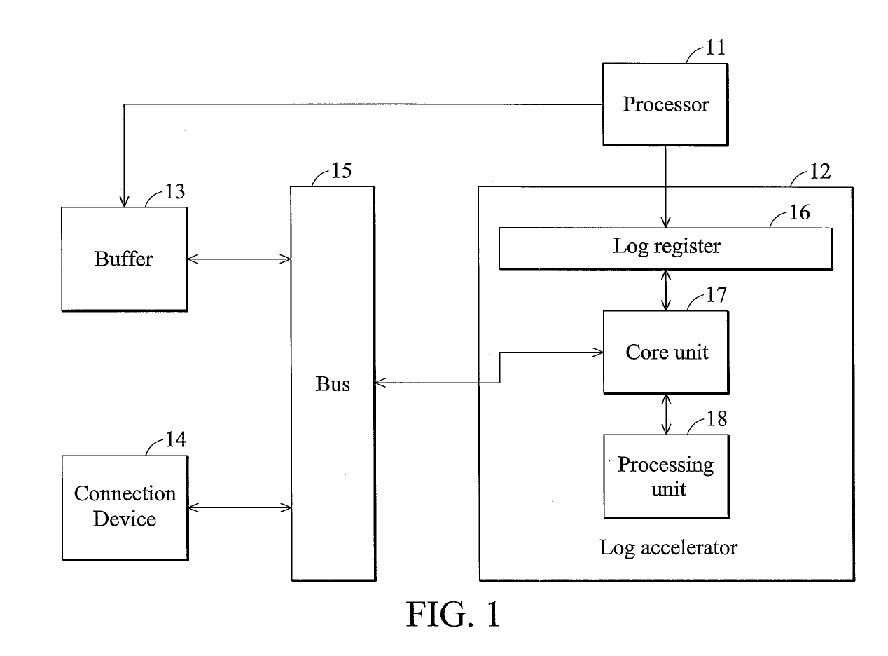

FIG. 1 is a hardware architecture diagram of a system logging apparatus according to an embodiment of the invention. A log is generated by a specific software module and comprises information regarding execution results, variable variations or output messages of the software module. The log can be traced or debugged by an external computer host during execution. The processor 11, during executing the program module, continuously writes logs to the buffer 13. Once a log is completely written in the buffer, the processor 11 triggers a log accelerator 12 of the apparatus, dedicated hardware circuits, to process and transmit the buffered log to a computer host. The log accelerator 12 comprises a log register 16, a core unit 17 and a processing unit 18. The log register 16 comprises a first bit and when the log is completely written to the buffer 13, the processor 11 asserts the first bit of the log register 12.

In an embodiment, the log comprises a ready flag and when the log is completely written in the buffer 13, the ready flag of the log is set to TRUE or one. The first bit of the log register 16 is asserted after the ready flag of the log is set to TRUE or one.

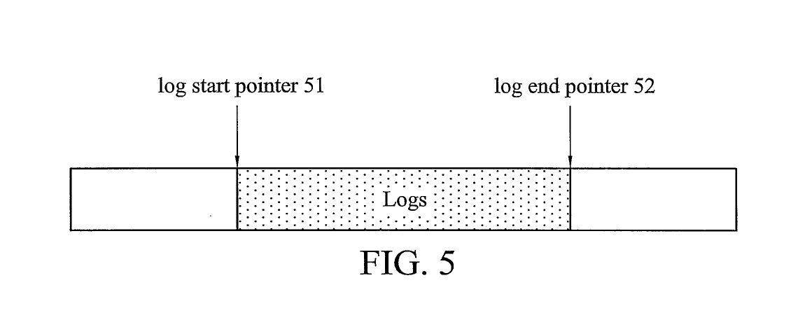

A log start pointer is provided to indicate a start position of written logs of the buffer 13, and a log end pointer is provided to indicate the next byte of an end position of written logs of the buffer 13. Please refer to FIG. 5. FIG. 5 is a schematic diagram of a ring buffer with two pointers according to an embodiment of the invention. In FIG. 5, only a part of the ring buffer is shown. The log start pointer 51 points to the start position of the written logs and the log end pointer 52 points to the next byte of the end of the last written log. Thus, the free buffer space thereof can be determined with reference to the log start pointer 51 and the log end pointer 52. The log start pointer 51 and the log end pointer 52 can be also utilized to determine whether the ring buffer contains no log to be processed (i.e. the ring buffer is empty). Before processing one log stored in the ring buffer, the log accelerator 12 determines whether the ring buffer contains no log to be processed. If not, the log accelerator 12 reads a log from the ring buffer to process, and when the read log is completely processed and transmitted to the computer host, the log start pointer 51 is moved to point to the start position of the next log (i.e. the next byte of the end position of the transmitted log). Before generating a new log, the processor 11 determines whether free buffer space thereof is sufficient to store the new log. If so, the processor 11 generates the new log, moves the log end pointer 52 to the next byte of the end of the new log to be written and writes the newly generated log in the ring buffer. If the logs stored in the ring buffer are all processed and transmitted to the computer host, the log start pointer 51 and the log end pointer 52 point to the same address of the ring buffer. In this embodiment, the ring buffer stops receiving the logs and discards follow-up logs when the ring buffer is full.

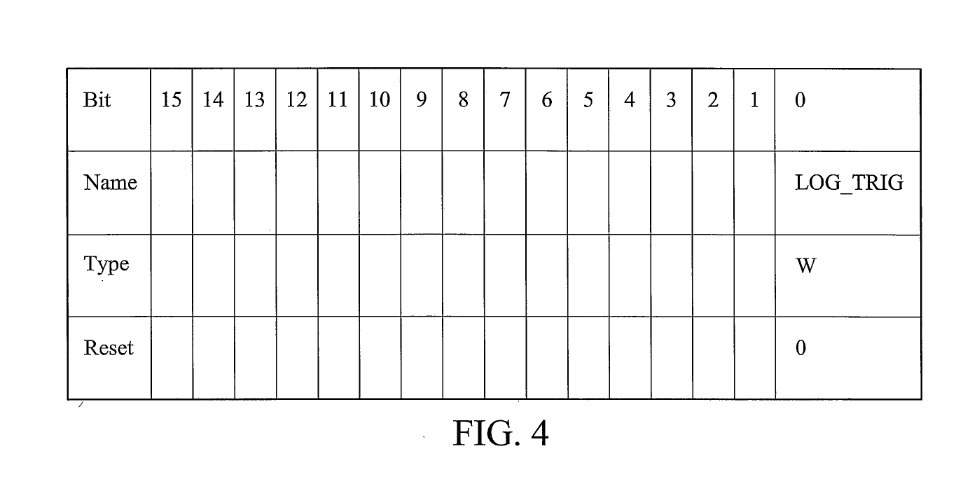

Referring to FIG. 1, the core unit 17 regularly detects whether the first bit of the log register 16 is asserted. When the first bit is asserted, the core unit 17 acquires a log from the buffer 13 via the bus 15. FIG. 4 shows a schematic diagram of an embodiment of the log register 16 according to the invention. In this embodiment, the log register 16 comprises 16 bits and only the first bit, bit 0, is utilized to trigger the log accelerator 12. Note that the triggering of log accelerator 12 is not limited by bit 0 of the log register 16. Any bit of the log register 16 can be defined to trigger the log accelerator 12. The core unit 17 regularly monitors the status of the first bit of the log register 16. The first bit is asserted by software programs when executed by the processor 11, and is de-asserted by the core unit 17. When the first bit is set to 1, this represents that the log accelerator 12 is triggered (specifically, the core unit 17 is triggered) by a software program. When the first bit is set to 0, this represent that the log accelerator 12 disables the triggering or has performed operations in response to the triggering. Once the log accelerator 12 processes logs of the buffer 13, the core unit 17 de-asserted the first bit.

After the core unit 17 acquires the log comprising a ready flag of one from the buffer 13, the core unit 17 transmits the log to the processing unit 18 for further processing. In an embodiment, the processing unit 18 may generate a checksum value for the received log and transmit the checksum value to the core unit 17. In another embodiment, the processing unit 18 may compress and/or encrypt the received logs and transmits the processing result to the core unit 17. The core unit 17 may further pack the processing results (e.g. a log with a checksum value, a compressed log, an encrypted log or any combinations) in a specific packet format. Then, the core unit 17 transmits the processing result to the computer host via the connection device 14. The connection device 14 may be a UART, USB, IEEE 1394 or other similar device.

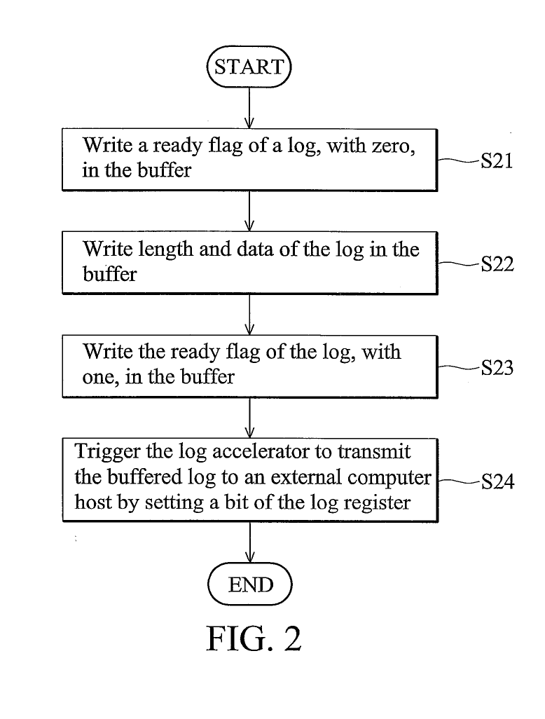

FIG. 2 is a flowchart illustrating log generation by a software program executed by a processor (e.g. 11 of FIG. 1) according to an embodiment of the invention. In step S21, the software program writes a ready flag of a log with logic 0 in a buffer (e.g. 13 of FIG. 1) to indicate that the log has not been completely stored. In step S22, the software program writes a length and data of the log to the buffer. After the log is completely written in the buffer, the software program writes the ready flag of the log with logic 1 to the buffer in step S23, and then, asserts a first bit of a log register (e.g. 16 of FIG. 1) to trigger a log accelerator (e.g. 12 of FIG. 1) in step S24. As a result, the log accelerator processes and transmits the buffered log to an external computer host when the log accelerator detects that the first bit of the log register has been asserted.

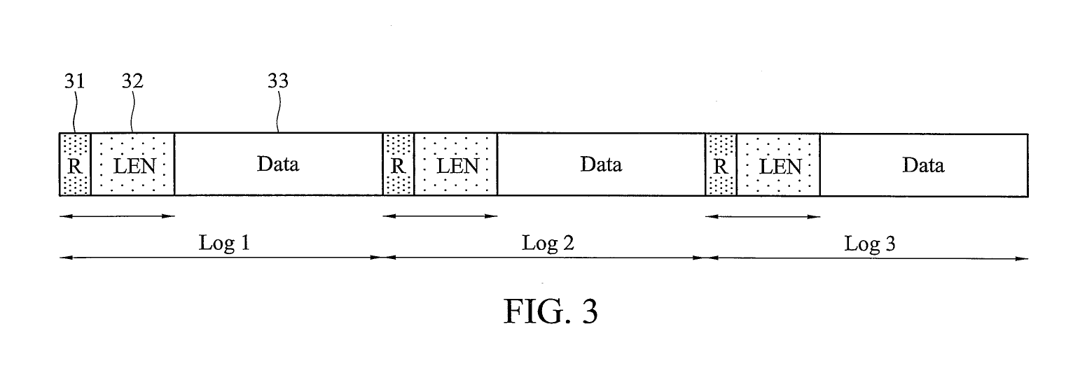

FIG. 3 is a schematic diagram of the data format of logs stored in a buffer (e.g. 13 of FIG. 1). In FIG. 3, three logs, Log 1, Log 2 and Log 3, are illustrated. The first log, Log 1, comprises a ready flag 31, a length 32 and log data 33. If the ready flag 31 of log 1 is set to 1, this means that the first log is completely written and ready to transmit. In an embodiment, the ready flag is only one bit, and in another embodiment, the ready flag is a byte. The length 32 stores the information indicating how many bytes a log has. In this embodiment, the logs are transmitted to the computer host in sequence. In other words, the logs stored in the buffer are transmitted in the first-in first-out (FIFO) rule.

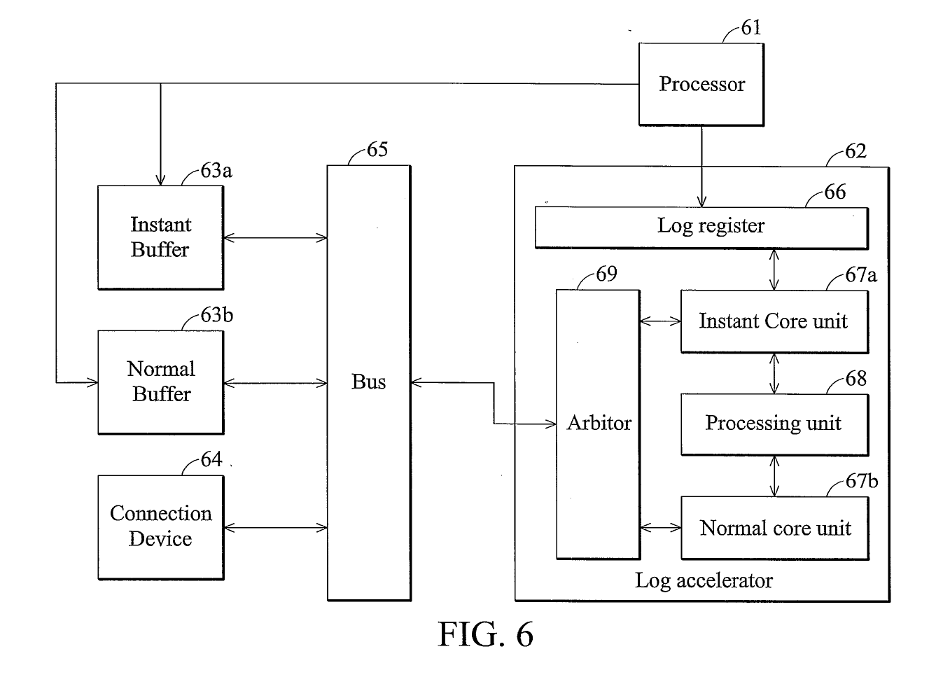

FIG. 6 is a hardware architecture diagram of a system logging apparatus according to another embodiment of the invention. Logs are generated by different types of software modules and each comprises information regarding execution results, variable variations or output messages. The log can be traced or debugged by an external computer host during execution. In this embodiment, the logs are classified into two types, instant logs and normal logs. Therefore, an instant buffer 63a and a normal buffer 63b are required for storing different types of logs.

The processor 61 loads and executes a software program to write a log to an instant buffer 63a or normal buffer 63b. Once the log is completely written in the instant buffer 63a or normal buffer 63b, the processor 61 triggers the log accelerator 62 of the system to process and transmit the buffered log to a computer host. The log accelerator 62 comprises a log register 66, an instant core unit 67a, a normal core unit 67b, a processing unit 68 and an arbiter 69. The log register 66 comprises a first bit and a second bit, and when the log is completely written to the instant buffer 63a or normal buffer 63b, the processor 61 asserts the first bit or the second bit of the log register 62.

In an embodiment, an instant log comprises a ready flag and when the instant log is completely written in the instant buffer 63a, the ready flag of the instant log is set to TRUE or one. The first bit of the log register 66 is asserted after the ready flag of the instant log is set to TRUE or one. Similarly, a normal log comprises a ready flag and when the normal log is completely written in the normal buffer 63b, the ready flag of the normal log is set to TRUE or one. The second bit of the log register 66 is asserted after the ready flag of the normal log is set to TRUE or one.

For each of the buffer 63a and normal buffer 63b, a log start pointer and a log end pointer are provided to indicate a start position and an end position of written logs thereof. The operation of the log start pointer and the long end pointer is similar to the pointers shown in FIG. 5 and are not illustrated here for brevity.

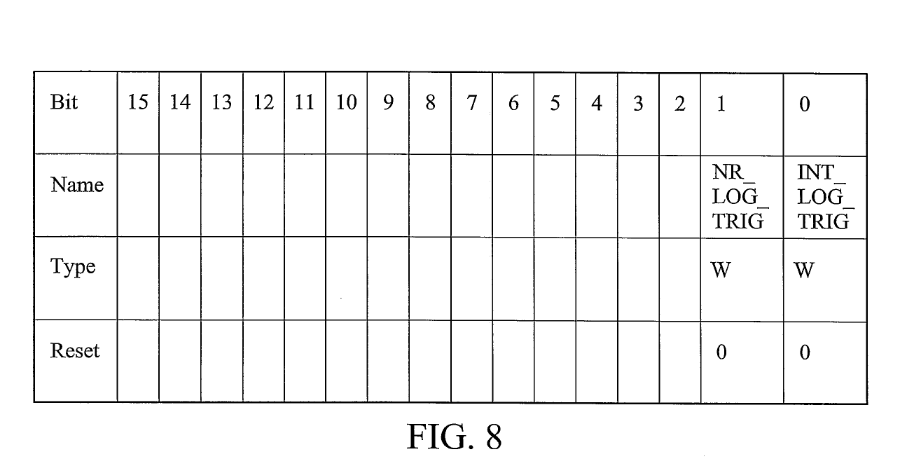

Referring to FIG. 6, the instant core unit 67a regularly detects whether the first bit of the log register 66 is asserted. When the first bit is asserted, instant core unit 67a acquires a log from the instant buffer 63a via the bus 65. FIG. 8 shows a schematic diagram of an embodiment of the log register 66 according to the invention. In this embodiment, the log register 66 comprises 16 bits and the first bit, bit 0, is utilized for the instant log to trigger the log accelerator 62. The instant core unit 67a regularly monitors the status of the first bit of the log register 66. The first bit is asserted by software programs when executed by the processor 11, and is de-asserted by the instant core unit 67a. When the first bit is set to 1, it represents that the log accelerator 62 is triggered (specifically, the instant core unit 67a is triggered) by a software program. When the first bit is set to 0, this represent that the log accelerator 62 disables the triggering or has performed operations in response to the triggering. Once the log accelerator 62 processes logs of the instant buffer 63a, the instant core unit 67a de-asserts the first bit. Note that the triggering of log accelerator 62 (i.e. instant core unit 67a) is not limited by bit 0 of the log register 66. Any bit of the log register 66 can be defined to trigger the log accelerator 62.

The normal core unit 67b regularly detects whether the second bit of the log register 66 is asserted. When the second bit is asserted, normal core unit 67b acquires a log from the normal buffer 63b via the bus 65. In the embodiment of FIG. 8, the log register 66 comprises 16 bits and the second bit, bit 1, is utilized for the normal log to trigger the log accelerator 62. The normal core unit 67b regularly monitors the status of the second bit of the log register 66. The second bit is asserted by software programs and is de-asserted by the normal core unit 67b. When the second bit is set to 1, this represents that the log accelerator 62 is triggered (specifically, the normal core unit 67b is triggered) by a software program. When the second bit is set to 0, this represent that the log accelerator 62 disables the triggering or has performed operations in response to the triggering. Once the log accelerator 62 processes logs of the normal buffer 63b, the normal core unit 67b de-asserts the second bit. Note that the triggering of log accelerator 62 (i.e. normal core unit 67b) is not limited by bit 1 of the log register 66. Any bit of the log register 66 can be defined to trigger the log accelerator 62.

After the instant core unit 67a or the normal core unit 67b acquires the logs comprising ready flags of ones from the instant buffer 63a or the normal buffer 63b, the instant core unit 67a or the normal core unit 67b transmits the logs to the processing unit 68 for further processing. In an embodiment, the processing unit 68 may generate a checksum value for the received log and transmit the checksum value to the instant core unit 67a or the normal core unit 67b. In another embodiment, the processing unit 68 may compress and/or encrypt the received logs and transmits the processing result to the instant core unit 67a or the normal core unit 67b. The instant core unit 67a or the normal core unit 67b may pack the processing result (e.g. a log with a checksum value, a compressed log, an encrypted log or any combinations) in a specific packet format.

In order to acquire logs from the instant buffer 63a and the normal buffer 63b and transmit the processing results to the computer host, the instant core unit 67a and the normal core unit 67b have to request the arbiter 69 to obtain the bus control. The arbiter 69 is coupled to the instant core unit 67a and the normal core unit 67b, and grants the bus control to one of the instant and normal core units 67a and 67b according to predetermined priorities thereof. In this embodiment, the priority of the instant log is higher than the priority of the normal log. In an embodiment, when no core units occupy the bus 65 and the instant core unit 67a and the normal core unit 67b simultaneously request the bus control, the arbiter 69 grants the bus control to the instant core unit 67a. In another embodiment, when the instant core unit 67a has occupied the bus 65 and the normal core unit 67b requests the bus control, the arbiter 69 grants the bus control to the normal core unit 67b until the instant core unit 67a completely processes logs of the instant buffer 63a. In still another embodiment, when the normal core unit 67b has occupied the bus 65 and the instant core unit 67a requests the bus control, the arbiter 69 grants the bus control to the instant core unit 67a until the normal core unit 67b completely processes one log of the normal buffer 63b. In still another embodiment, when the normal core unit 67b has occupied the bus 65 and the instant core unit 67a requests the bus control, the arbiter 69 immediately interrupts the normal core unit 67b and grants the bus control to the instant core unit 67a.

In an embodiment, when the normal buffer 63b is full, the software program cannot write any of new normal logs to the normal buffer 63b. In another embodiment, when the instant buffer 63a is full, logs of the instant buffer 63a are cleared in order to allocate free space for newly incoming instant logs.

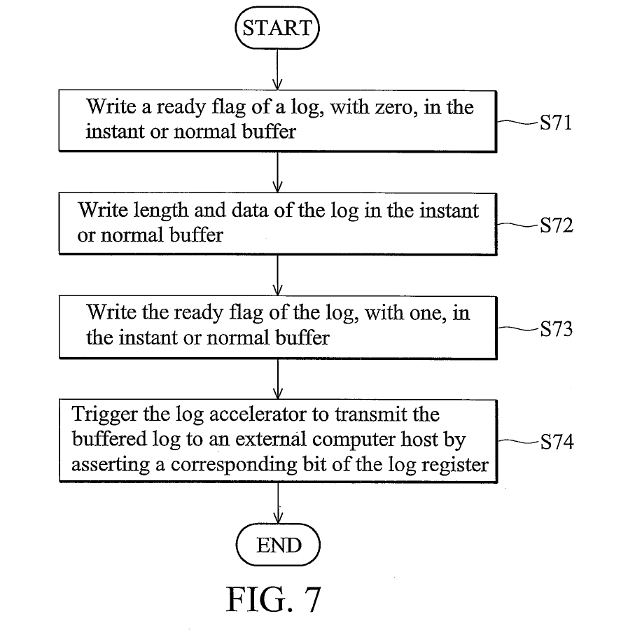

FIG. 7 is a flowchart illustrating log generation by a software program executed by a processor (e.g. 61 of FIG. 6) according to another embodiment of the invention. In step S71, a software program writes a ready flag of an instant log or a ready flag of a normal log with logic 0 in an instant buffer (e.g. 63a of FIG. 6) or a normal buffer (e.g. 63b of FIG. 6) to indicate that the log has not been completely stored. In step S72, the software program writes a length and data of the instant log or the normal log to the instant of normal buffer. After the instant log or the log is completely written in the buffer, the software program writes the ready flag of the instant log or the normal log with logic 1 in step S33, and then, asserts a first or second bit of a log register (e.g. 66 of FIG. 6) to trigger a log accelerator (e.g 62. of FIG. 6) in step S74. As a result, the log accelerator processes and transmits the buffered log to an external computer host when the log accelerator detects that the first or second bit of the log register is asserted.

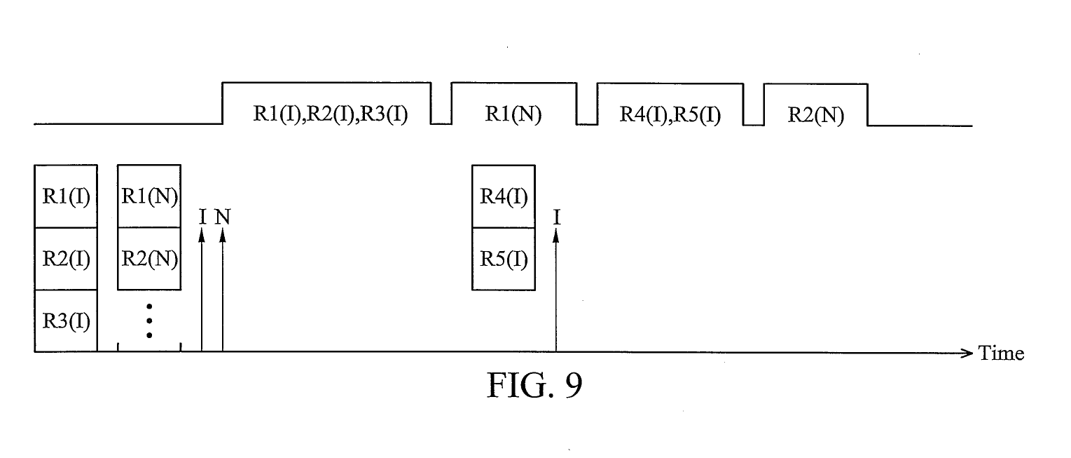

FIG. 9 is a schematic diagram showing an exemplary log transmission according to the invention. In the beginning, a log accelerator (e.g. 62 of FIG. 6) detects that a first bit and a second bit of a log register (e.g. 66 of FIG. 6) have been asserted, indicating that instant logs R1(I), R2(I), R3(I) and the normal logs R1(N) and R2(N) are ready to be transmitted. The log accelerator sequentially transmits the instant logs R1(I), R2(I) and R3(I), and the normal logs R1(N) and R2(N) according to their priorities. During the transmission of the normal log R1(N), the log accelerator further detects that two instant logs R4(I) and R5(I) are ready to be transmitted by inspecting the first bit of the log register, and the log accelerator transmits the instant logs R4(I) and R5(I) after the transmission of the normal log R1(N). After the transmission of the instant logs R4(I) and R5(I), the log accelerator transmits the remainig normal log R2(N). In some embodiments, the log accelerator may interrupt the transmission of the normal log R1(N) and then transmits the instant logs R4(I) and R5(I). After the transmission of instant logs R4(I) and R5(I), the log accelerator transmits the remaining part of normal log R1(N) and R2(N).

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for system logging, comprising:
a buffer storing a log;
a log register comprising a bit; and
a core unit coupled to the buffer and the log register to acquire and transmit the log to an external computer host when detecting that the bit is asserted.

2. The apparatus as claimed in claim 1, wherein the log comprises a ready flag and after a software program executed by a processor completely writes the log to the buffer, the software program sets the ready flag of the buffer to TRUE or one, and asserts the bit.

3. The apparatus as claimed in claim 1, wherein the core unit regularly monitors the bit of the log register to inspect whether the bit is asserted.

4. The apparatus as claimed in claim 1, further comprising a processing unit receiving the log from the core unit and generating a processing result corresponding to the log and transmitting the processing result to the core unit.

5. The apparatus as claimed in claim 4, wherein the processing unit generates a checksum value for the log, compresses the log or encrypts the log.

6. The apparatus as claimed in claim 1, wherein the bit of the log register is de-asserted by the core unit.

7. The apparatus as claimed in claim 1, wherein a log start pointer is provided to indicate a start position of written logs of the buffer, and a log end pointer is provided to indicate the next byte of the last written log of the buffer.

8. The apparatus as claimed in claim 7, wherein a software program executed by a processor determines whether free buffer space of the buffer is sufficient to store a new log, and if so, the software program generates and stores the new log from a position pointed by the log end pointer, and moves the log end pointer to the next byte of the newly written log.

9. The apparatus as claimed in claim 7, wherein the core unit determines whether the buffer contains no log to be processed according to the log start pointer and the log end pointer, and if not, the core unit transmits the log to the external computer host, and moves the log start pointer to the next byte of the transmitted log.

10. An apparatus for system logging, comprising:
a first buffer storing a first log;
a second buffer storing a second log;
a log register comprising a first bit and a second bit;
a first core unit coupled to the first buffer and the log register to acquire and transmit the first log to an external computer host when detecting that the first bit is asserted;
a second core unit coupled to the second buffer and the log register to acquire and transmit the second log to the external computer host when detecting that the second bit is asserted; and
an arbiter coupled to the first and second core units, granting a bus control to the first core unit or the second core unit according to predetermined priorities of the first and the second core units.

11. The apparatus as claimed in claim 10, wherein the first core unit requests the bus control to the arbiter before acquiring the first log from the first buffer, and the second core unit requests the bus control to the arbiter before acquiring the second log from the second buffer.

12. The apparatus as claimed in claim 10, wherein logs of the first buffer are cleared when the first buffer is full, and a software program executed by a processor cannot write any of new logs to the second buffer when the second buffer is full.

13. The apparatus as claimed in claim 10, wherein the priority of the first core unit is higher than the priority of the second core unit.

14. The apparatus as claimed in claim 13, wherein when the first and second core units are not occupy a bus and simultaneously request the bus control of the bus, the arbiter grants the bus control to the first core unit.

15. The apparatus as claimed in claim 13, wherein when the first core unit has occupied a bus and the second core unit requests the bus control of the bus, the arbiter grants the bus control to the second core unit until the first core unit completes the whole log transmissions.

16. The apparatus as claimed in claim 13, wherein when the second core unit has occupied a bus and the first core unit requests the bus control of the bus, the arbiter grants the bus control to the first core unit until the second core unit completes log transmission of one second log.

17. The apparatus as claimed in claim 13, wherein when the second core unit has occupied a bus and the first core unit requests the bus control of the bus, the arbiter interrupts the second core unit and grants the bus control to the first core unit.

18. A method for system logging, performed by a processor of an electronic apparatus, comprising:
writing a log to a buffer; and
asserting a bit of a log register to direct a core unit of the electronic apparatus to transmit the log to an external computer host after completely writing the log.

19. The method as claimed in claim 18, wherein the writing step further comprises:
writing a ready flag of the log to indicate that the log has not been completely written;
writing data of the log; and
updating the ready flag of the log to indicate the log has been completely written.

20. The method as claimed in claim 18, wherein the core unit is a dedicated hardware circuit.
